(19) United States
(12) Patent Application Publication
(10) Pub. No.: US 2024/0258503 A1
(43) Pub. Date: Aug. 1, 2024

(54) BATTERY ELECTRODE AND A METHOD OF MANUFACTURING THEREOF

(71) Applicants: HYUNDAI MOTOR COMPANY, Seoul (KR); KIA CORPORATION, Seoul (KR)

(72) Inventors: Hannah Song, Ansan-si (KR); Yongil Cho, Seoul (KR); Chanbum Park, Suwon-si (KR); Hyeonha Lee, Anyang-si (KR); Hyunjin Kim, Daegu (KR)

(73) Assignees: HYUNDAI MOTOR COMPANY, Seoul (KR); KIA CORPORATION, Seoul (KR)

(21) Appl. No.: 18/419,813

(22) Filed: Jan. 23, 2024

(30) Foreign Application Priority Data
Jan. 27, 2023 (KR) 10-2023-0010664

(51) Int. Cl. H01M 4/36; H01M 4/04; H01M 4/62

(52) U.S. Cl. CPC H01M 4/366; H01M 4/0416; H01M 4/0435; H01M 4/622

(57) ABSTRACT

A battery electrode and its manufacturing method. In particular, the battery electrode includes: a separator; a first composite layer disposed on the separator and having a first active material, a first binder, and a first conductive material; a second composite layer disposed on the first composite layer and having a second active material, a second binder, and a second conductive material; a third composite layer disposed on the second composite layer and having a third active material, a third binder, and a third conductive material; and a substrate disposed on the third composite layer. A resistance of the first composite layer is less than that of the second composite layer, and a resistance of the second composite layer is less than that of the third composite layer.

### CROSS-REFERENCE TO RELATED APPLICATION

This application claims priority to and the benefit of Korean Patent Application No. 10-2023-0010664 filed on Jan. 27, 2023, the entire contents of which are incorporated herein by reference.

### BACKGROUND

### (a) Field

The present disclosure relates to an electrochemical device. More particularly, the present disclosure relates to battery electrode, and its manufacturing method.

### (b) Description of the Related Art

As interest in energy storage technology increases, research and development in fields that require energy storage such as mobile phones, laptops, energy storage systems (ESS), and electric vehicles (Electric Vehicles, EV) are active. Particularly, in electrochemical devices, there is active movement to develop new electrodes to improve the capacity, density, and specific energy of the secondary battery, along with the development of batteries that can be repeatedly charged and discharged.

As interest in the electrochemical device increases, research is being conducted to improve the electrochemical device's low resistance, high-capacity, mechanical characteristics, or producibility, as well as to improve safety by preventing a battery from igniting. When manufacturing the battery, for example, a secondary battery, through a wet process, a drying process to evaporate the solvent is required, and hot air is used in the drying process. The hot air generates a convection phenomenon within the electrode, causing a migration phenomenon in which the binder material, relatively light, is lifted to the electrode surface. Due to the migration phenomenon, electrochemical resistance increases on the surface in contact with the separator at the negative electrode, and when charging, lithium (Li) metal is precipitated on the negative electrode surface, damaging the separator and causing a short circuit of the battery. Improvement is needed as a fire in the secondary battery may occur when the battery is short-circuited, but there is a problem that inevitably results in non-uniform binder distribution in the battery's manufacturing process.

The above information disclosed in this Background section is provided only to enhance the understanding of the background of the disclosure. Therefore, the Background section may contain information that does not form the prior art that is already known to a person of ordinary skill in the art.

### SUMMARY

The present disclosure provides an electrode for a battery in which the binder of the battery is uniformly distributed and stability is secured through fire prevention of the battery.

The present disclosure also provides a battery electrode manufacturing method with the above-described advantages.

According to an embodiment of the present disclosure, the battery electrode includes: a separator; a first composite layer disposed on the separator and having a first active material, a first binder, and a first conductive material; and a second composite layer disposed on the first composite layer and having a second active material, a second binder, and a second conductive material. The battery electrode further including: a third composite layer disposed on the second composite layer and having a third active material, a third binder, and a third conductive material; and a substrate disposed on the third composite layer. A resistance of the first composite layer is less than that of the second composite layer, and a resistance of the second composite layer is less than that of the third composite layer.

In an embodiment, the resistance of the first composite layer may be in a range of 40 to 60%, the resistance of the second composite layer may be in a range of 60 to 70%, and the resistance of the third composite layer may be in a range of 65 to 85%.

In an embodiment, the battery electrode may include at least one of a first active material, a second active material, and a third active material. The first active material, the second active material, and the third active material include a carbon-based material and a metal-based material.

In an embodiment, a content of the first binder is less than a content of the second binder, a content of the second binder is less than a content of the third binder, and a content of the first binder is in a range of 0.1 to 1.5 wt % based on the overall composition of the first composite layer. A content of the second binder is in a range of 0.5 to 2.5 wt % based on the overall composition of the second composite layer, and a content of the third binder is in a range of 1.0 to 3.5 wt % based on the overall composition of the third composite layer.

In an embodiment, the first binder, the second binder, and the third binder are independently selected from the group consisting of polyvinylidene fluoride-hexafluoropropylene, polyvinylidene fluoride, polyacrylonitrile, polymethyl methacrylate, styrene-butadiene rubber, carboxyl methyl cellulose, and combination thereof.

In an embodiment, a particle size of the first composite layer is in a range of 12 to 20 μm, a particle size of the second composite layer is in a range of 20 to 25 μm, and a particle size of the third composite layer is in a range of 25 to 30 μm.

According to an embodiment of the present disclosure, a method of manufacturing battery electrode, includes: preparing a first electrode powder film; preparing a second electrode powder film and a third electrode powder film respectively by the same method as preparing the first electrode powder film; and preparing a composite film such that the first electrode powder film, the second electrode powder film, and the third electrode powder film are sequentially stacked on top of one another. The method further includes laminating by pressing at least one of the composite films and a substrate together. A resistance of the first electrode powder film is less than that of the second electrode powder film, and a resistance of the second electrode powder film is less than that of the third electrode powder film.

In an embodiment, the method further comprises: preparing a first electrode powder film. The method also includes mixing a first electrode powder, a second electrode powder, and a third electrode powder respectively. The method also includes preparing a second electrode powder film and a third electrode powder film respectively by the same method as preparing the first electrode powder film. The first electrode powder includes a first active material, a first binder, and a first conductive material. The second electrode powder includes a second active material, a second binder, and a second conductive material. The third electrode powder includes a third active material, a third binder, and a third conductive material. A content of the first binder is less than that of the second binder, and a content of the second binder is less than that of the third binder.

In an embodiment, a content of the first conductive material is greater than the content of the second conductive material, and a content of the second conductive material is greater than the content of the third conductive material.

In an embodiment, the method further comprises: manufacturing the first electrode powder film; and manufacturing the second electrode powder film and third electrode powder film using the same method as manufacturing the first electrode powder film by pressurizing the first electrode powder, the second electrode powder, and the third electrode powder respectively into a film. The method also includes edge slitting the first electrode powder film, the second electrode powder film, and the third electrode powder film; and winding each of the edge-slitted first electrode powder film, second electrode powder film, and third electrode powder film.

In an embodiment, the method further includes controlling a thickness of each of the first electrode powder, the second electrode powder, and the third electrode powder when manufacturing each of the first electrode powder film, the second electrode powder film, and the third electrode powder film.

In an embodiment, the method further includes uniformly cutting on both sides of a length direction of the first electrode powder film, the second electrode powder film, and the third electrode powder film through a cutting unit between the manufacturing of the first electrode powder film, the second electrode powder film, and the third electrode powder film and the winding of each of the edge-slitted first electrode powder film, second electrode powder film, and third electrode powder film.

In an embodiment, the laminating step includes: unwinding the composite film and the substrate; and bonding a first mixture film, the substrate, and a second mixture film in that order by applying at least one of heat and pressure to the unwinding composite film and the substrate.

In an embodiment, the method further includes, after forming the battery electrode, winding the bonded films onto a battery electrode roll of a certain length.

In an embodiment, a battery electrode, includes: a separator; a first composite layer disposed on the separator and having a first active material, a first binder, and a first conductive material; and a second composite layer disposed on the first composite layer and having a second active material, a second binder, and a second conductive material. The battery electrode further includes: a third composite layer disposed on the second composite layer and includes a third active material, a third binder, and a third conductive material; and a substrate disposed on the third composite layer. A resistance of the first composite layer is less than that of the second composite layer, and a resistance of the second composite layer is less than that of the third composite layer. As a result, the risk of lithium precipitation due to increased resistance of the upper surface of the electrode is reduced, and adherence between the substrate and composite layers is increased, thereby providing a battery electrode with excellent stability.

In another embodiment of the present disclosure, a manufacturing method of a battery electrode having the advantages can be provided.

### BRIEF DESCRIPTION OF THE DRAWINGS

These drawings are for reference only in describing embodiments of the present disclosure. Therefore, the technical idea of the present disclosure should not be limited to the accompanying drawings.

FIG. 1 shows a battery electrode, according to an embodiment.

FIG. 2A is a flowchart of a battery electrode manufacturing method according to an embodiment.

FIGS. 2B-2D schematically show each step of a battery electrode manufacturing method.

### DETAILED DESCRIPTION

The terms such as first, second, and third are used to describe various portions, components, regions, layers, and/or sections, but various parts, components, regions, layers, and/or sections are not limited to these terms. These terms are only used to distinguish one part, component, region, layer, or section from another part, component, region, layer, or section. Accordingly, a first part, component, region, layer, or section described below may be referred to as a second part, component, region, layer, or section without departing from the scope of the present disclosure.

Terminologies as used herein are to mention only a specific embodiment, and are not to limit the present disclosure. Singular forms used herein include plural forms as long as phrases do not clearly indicate an opposite meaning. The terms “including/comprising” as used herein concretely indicate specific characteristics, regions, integers, numbers, steps, operations, elements, and/or components, and are not to exclude the presence or addition of other specific characteristics, regions, integers, numbers, steps, operations, elements, and/or components.

When any portion is referred to as being “above” or “on” another portion, any portion may be directly above or on another portion or be above or on another portion with the other portion interposed therebetween. In contrast, when any portion is referred to as being “directly on” another portion, the other portion is not interposed between any portion and another portion.

Unless defined otherwise, all terms including technical terms and scientific terms as used herein have the same meaning as the meaning generally understood by a person having ordinary skill in the art to which the present disclosure pertains. Terms defined in a generally used dictionary are additionally interpreted as having the meaning matched to the related art document and the currently disclosed contents and are not interpreted as ideal or formal meaning unless defined.

When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail. However, the embodiments are presented as examples, and the present disclosure is not limited thereby. Additionally, the present disclosure is only defined by the category of the claim range, which is described below.

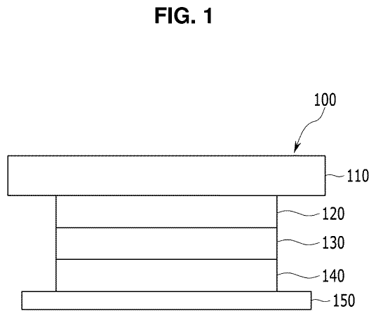

FIG. 1 shows a battery electrode, according to an embodiment.

Referring to FIG. 1, an embodiment of the present disclosure, the battery electrode 100 includes a separator 110, a first mixture layer 120, a second mixture layer 130, a third mixture layer 140, and a substrate 150. The battery electrode 100 may include batteries using liquid/polymer electrolytes, such as lithium-ion batteries, lithium-sulfur batteries, and lithium metal batteries, as well as all-solid batteries using solid electrolytes.

The separator 110 is disposed between the battery electrodes and may prevent short circuit of the battery electrodes. In an embodiment, the separator 110 may be a porous polymer substrate, and the pore size and porosity present in the porous polymer substrate may be, as non-limiting examples, in a range of 0.01 to 50 micrometers (μm), and in a range of 10 to 95%. In an embodiment, the porous polymer substrate includes a porous coating layer containing an inorganic material particle and a polymer binder on at least one side of the porous a polymer substrate to improve mechanical strength and suppress shorting of the electrodes.

The porous polymer substrate is a non-limiting example, any one polymer selected from the group consisting of polyethylene, polypropylene, polyethylene terephthalate, polybutylene terephthalate, polyester, polyacetal, polyamide, polycarbonate, polyimide, polyetheretherketone, polyaryletherketone, polyetherimide, polyamideimide, polybenzimidazole, polyethersulfone, polyphenylene sulfide, polyethylene naphthalene, or a combination thereof.

The first composite layer 120 is disposed on the separator 110 and may include the first active material, first binder, and first conductive material. The second composite layer 130 may be disposed on the first composite layer 120 and include a second active material, a second binder, and a second conductive material. The third composite layer 140 may be disposed on the second composite layer 130 and may include a third active material, a third binder, and a third conductive material.

In an embodiment, the resistance of the first composite layer 120 may be smaller than that of the second composite layer 130, and the resistance of the second composite layer 130 may be smaller than that of the third composite layer 140. In an embodiment, the first composite layer 120 may have a smaller electrochemical resistance than the second composite layer 130, the second composite layer 130 may have a smaller electrochemical resistance than the third composite layer 140, and as the electrochemical resistance is smaller, charge efficiency may increase.

In an embodiment, the resistance of the first composite layer 120 may be in a range of 40 to 60%. Specifically, the resistance of the first composite layer 120 may be in a range of 45 to 55%. In an embodiment, the resistance of the second composite layer 130 may be in a range of 60 to 70%. Specifically, the resistance of the second composite layer 130 may be in a range of 63 to 68%.

Specifically, the resistance of the third composite layer 140 may be in a range of 65 to 85%. Specifically, the resistance of the third composite layer 140 may be in a range of 70 to 80%. More specifically, the resistance of the third composite layer 140 may be in a range of 72 to 78%. A charge efficiency may increase as resistance increases in the order of the first composite layer 120, the second composite layer 130, and the third composite layer 140 are stacked as described above.

In an embodiment, the charge efficiency of the first composite layer 120 may be in a range of 90% or more, the second composite layer 130 may be in a range of 80 to 90%, and the third composite layer 140 may be in a range of 70% or less. Because the charge efficiency of the first composite layer 120, the second composite layer 130, and the third composite layer 140 is different, and the charge efficiency decreases in the order in which the first composite layer 120, the second composite layer 130, and the third composite layer 140 are stacked, the electrochemical resistance increases. The electrochemical resistance can be inferred through the charge efficiency value of the ratio of 2C charge capacity to 0.33C charge capacity based on a graphite negative electrode with a high loading of 30 milligrams per square centimeter (mg/cm²).

Specifically, the electrochemical resistance of the composite layer in contact with the separator 110 is smaller than the resistance of the composite layer in contact with the substrate 150, thereby preventing risks such as lithium precipitation and providing an electrode with guaranteed stability. Since the electrode can be manufactured through a dry process, there is an advantage that the value of the electrochemical resistance can be predetermined to be different.

The first to third active material may be a negative active material, and the negative active material may be a lithium-containing oxide, for example, lithium-containing transition elements oxide such as Li₄Ti₅O₁₂, TiNb₂O₇, or TiO₂ may be used. Specifically, the negative active material may include various types of negative active materials, such as, for example, carbon-based material or metal-based material. The carbon-based material can be applied in various forms, including artificial graphite, natural graphite, or hard carbon. Various types of metal-based materials such as silicon (Si) and tin (Sn) can be applied.

In an embodiment, the particle size of the first composite layer 120 may be in a range of 12 to 20 μm, the particle size of the second composite layer 130 may be in a range of 20 to 25 μm, and the particle size of the third composite layer 140 may be in a range of 25 to 30 μm. Specifically, the particle size of the first composite layer 120 may be in a range of 15 to 18 μm, the particle size of the second composite layer 130 may be in a range of 20 to 22 μm, and the particle size of the third composite layer 140 may be in a range of 25 to 28 μm.

As the particle sizes of the first composite layer 120 to the third composite layer 140 are different, electrochemical resistance, specifically ion resistance, may vary. Specifically, the smaller the particle size, the shorter the lithium ion conduction channel is, which may lower the ion resistance. Accordingly, the resistance of the first composite layer 120 may be smaller than that of the second composite layer 130, the resistance of the second composite layer 130 may be smaller than the resistance of the third composite layer 140, and the particle size for each composite layer is different, resulting in controlling excellent electrochemical resistance values.

A binder of the first to the third binders may be a component that assists in the combination of the negative active material and the conductive material and the connection to the current collector. The first to third binder may be a variety of binder polymers such as polyvinylidene fluoride-hexafluoropropylene, polyvinylidene fluoride, polyacrylonitrile, polymethyl methacrylate, styrene-butadiene rubber, and carboxyl methyl cellulose. The binder may be a component that physically maintains the structure of the electrode.

In a general method of manufacturing an electrode through a wet slurry, during the drying process using hot air, the binder content changes along the electrode thickness direction due to binder migration by convection. Specifically, the binder content in the uppermost layer in contact with the separator 110 may increase, and the binder content in the lowest layer in contact with the substrate may decrease.

The one with a higher binder content may have lower porosity and thus lower electrolyte solution impregnation. Additionally, as an insulator, it has the problem of interfering with electronic conduction and may cause problems that impede electronic conduction. The present disclosure is in the order of first composite layer 120, second composite layer 130, and third composite layer 140. Additionally, as the binder content increases, the impregnation and electrical conductivity of the top first composite layer 120 in contact with the separator 110 are increased to increase electrochemically. It can have the advantage of lowering resistance.

In an embodiment, the content of the first binder may be less than the content of the second binder, and the content of the second binder may be less than the content of the third binder. In an embodiment, the content of the first binder is in a range of 0.1 to 1.5 wt % based on the first composite layer's 120 entire composition, the content of the second binder is 1.5 to 2.5 wt % based on the second composite layer's 130 entire composition, and the content of the third binder may be in a range of 2.5 to 3.5 wt % based on the third composite layer's 140 entire composition. The content of the binder of the first to third binders may refer to the content of a solid.

The higher the content of the binders, the higher the resistance of the composite layer can be. The resistance of the first composite layer 120 in contact with the separator is low, and as it moves from the separator to the substrate, the resistance of the sequentially composite layer increases. Therefore, there is an advantage in preventing an increase in the risk of lithium precipitation due to the low resistance of the first composite layer 120 in contact with the separator 110.

The first to third conductive material is one that has conductivity without causing chemical changes in the battery. For example, graphite such as natural graphite or artificial graphite, carbon black such as acetylene black, ketjen black, channel black, furnace black, lamp black, and summer black may be used. Additionally, conductive fiber such as carbon fiber and metal fiber, fluoride carbon, metal powders such as aluminum and nickel powder, conductive whiskeys such as zinc oxide and potassium titanate, conductive metal oxides such as titanium oxide, and conductive polymers such as polyphenylene derivatives can be used.

The substrate 150 includes a substrate disposed on the third composite layer 140. As the substrate 150 is in contact with the third composite layer 140, which has the highest resistance, there is an advantage in securing adherence between the substrate 150 and the third composite layer 140. Therefore, as the resistance of the first composite layer 120 in contact with the separator 110 is low and the resistance of the third composite layer 140 in contact with the substrate 150 is high, the electrochemical resistance at the electrode surface near the separator is lowered, thereby reducing the risk of fire. It is possible to provide an electrode for a battery that can prevent and secure adherence between the substrate and the electrode composite layers.

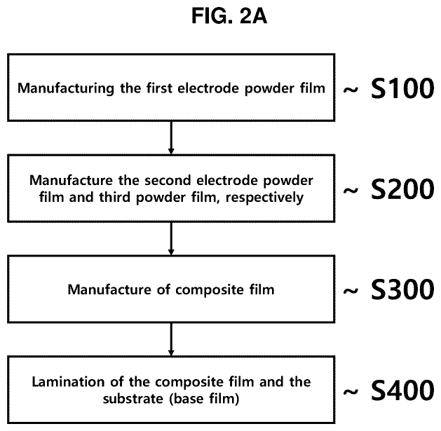

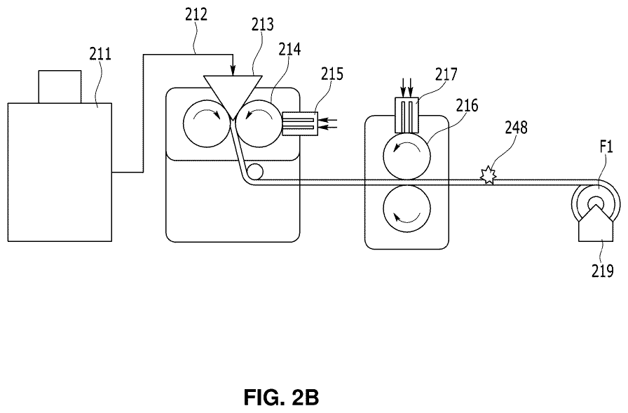

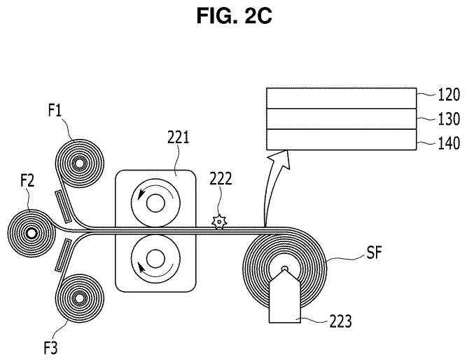

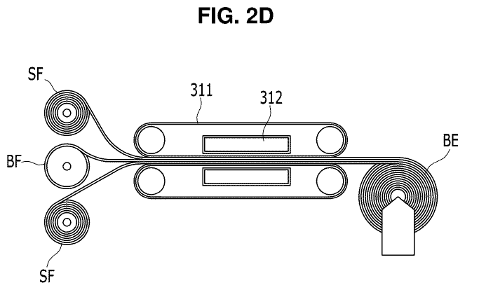

FIG. 2A is a flowchart of the battery electrode manufacturing method according to an embodiment, and FIG. 2B to FIG. 2D schematically shows each step of the battery electrode manufacturing method.

Referring to FIG. 2A, a method of manufacturing a battery electrode. The method includes: preparing a first electrode powder film (S100); and preparing a second electrode powder film and a third electrode powder film respectively by the same method as the step for preparing the first electrode powder film (S200). The method also includes: preparing a composite film such that the first electrode powder film, the second electrode powder film, and the third electrode powder film are sequentially stacked (S300); and laminating by pressing at least one of the composite films and a substrate together (S400). In the case of a battery electrode according to an embodiment of the present disclosure, the resistance of the first electrode powder film is smaller than the resistance of the second electrode powder film, and the resistance of the second electrode powder film is smaller than the resistance of the third electrode powder film. By lowering the electrochemical resistance on the electrode surface near the separator 110, it is possible to prevent the risk of fire and provide a battery electrode that can secure adherence between the substrate and the electrode composite layers. A detailed description of this can be provided in FIG. 1.

Step S100 for manufacturing the first electrode powder film may include a mixing step for the first electrode powder. The first electrode powder may include the powder of the first active material, the powder of the first binder, and the powder of the first conductive material. A detailed description of this is in the same range that does not contradict FIG. 1.

Therefore, the first active material has a smaller particle size compared to the second active material and third active material described below. The powder of the first binder has a smaller content compared to the powder of the second binder and third binder described below. Additionally, there may be no difference between the powder of the first conductive material and the powder of the second conductive material and the third conductive material, which is described below.

The mixing step can be performed by a mechanical external force of the mixing vessel 211. The mechanical external force may be a shear force as a non-limiting example, and the shear force may be generated to uniformly mix the powders. For example, a rotational blade may be further included inside the mixing vessel 211, shearing force is generated by the torque of the blade, and the powder can be mixed by the shearing force. In an embodiment, the torque of the blade can control the degree of shear force by controlling the rotation of the blade in the same or opposite direction.

In an embodiment, the blade may be configured to rotate while maintaining a certain gap between the blade and the inner surface of the mixing vessel 211 to convert the powder mixture into fiber to form a fiber-mixture. As the blade rotates, it decomposes the first binder powder, and as the first binder powder decomposes, cohesion between the first active material powder and the first conductive material powder can occur. The second electrode powder film and third electrode powder film can be produced using the same method as step S100 for producing the first electrode powder film.

Step S100 for manufacturing the first electrode powder film may include the step of pressurizing the first electrode powder into a film. In the film forming step, the mixed first electrode powder, the second electrode powder, and the third electrode powder can each be delivered to the feeder 213 through the mixing vessel 211 and the connector 212. The mixture discharged by the feeder 213 is put between at least one rotating roller 214 and the powder is pressed to produce a film. In an embodiment, at least one roller 214 may be used, for example, a pair of rollers 214 may be used. As illustrated in FIG. 2B. the pair of rollers 214 and a pressurized cylinder 215 are used, and the pressurized cylinder 215 may be controlled so that the gap between the rollers 214 is maintained constant.

In an embodiment, the film forming step further includes a heating roller (not shown), which uses the heating roller to simultaneously apply at least one of heat and pressure to the powders. It can control the binder to have cohesion within the powder.

The step of manufacturing the first electrode powder into a film may further include a step of controlling the thickness of the first electrode powder. The step of controlling the thickness of the first electrode powder is to control the thickness by going through an additional pressing process on the first electrode powder that has been filmed. For thickness control, at least one or more rollers may be included, for example a pair of rollers 216. In an embodiment, a pressurized cylinder 217 may be further included to control the gap between the rollers 216. For example, the first electrode powder film can be controlled to a thickness range of 10 to 200 μm.

In an embodiment, the step to control the thickness of the first electrode powder may be thickness controlled by equipment such as a roll press and a flat press. For example, two or more roll stands may be required to control the compression rate of a film made from the first electrode powder from 20 to 50%. This can be equally applied to the step of manufacturing the second electrode powder and the third electrode powder into a film.

Step S100 for manufacturing the first electrode powder film may include a step of cutting the first electrode powder that has been formed into a film. In the step of cutting the first electrode powder, both edges of the filmed first electrode powder can be cut uniformly using the cutting unit 218. This may be achieved by cutting the non-uniform edge of the battery electrode such that the battery electrode is manufactured.

For example, the step for cutting the first electrode powder can be performed by using a circular knife having top and bottom blades. Additionally, cutting the first electrode powder can be performed using cutter blades that are positioned on both sides corresponding to the width of the battery electrode. Both edges of the first electrode powder, discharged in the form of a film, from the formation process or thickness step, can be cut uniformly. This can be equally applied to the second electrode powder film and the third electrode powder film.

Step S100 for manufacturing the first electrode powder film may include a step of winding the first electrode powder film that has gone through the cutting step. The winding step is to manufacture electrode roll 219 by winding the first electrode powder film to a set length. Through the winding step, the first electrode powder film can be manufactured into a roll-shaped first electrode powder film F1. This can be equally applied to the filmized second electrode powder and the filmized third electrode powder.

Step S200, which manufactures the second electrode powder film and third electrode powder film using the same method as the step for manufacturing the first electrode powder film, can be applied equally in a non-contradictory range, compared to step S100 for manufacturing the first electrode powder film described above, which only the type and content of the second and third binder/conductive material powder, are different. Therefore, the second electrode powder film F2 and the third electrode powder film F3 can be manufactured through the same process as the first electrode powder film F1. The first electrode powder film to the third electrode powder film (i.e., F1, F2 and F3) correspond to the first composite layer to the third composite layer (i.e., 120, 130 and 140), as described in FIG. 1. A detailed description of the type and content of the second and third active material/binder/conductive material powder are the same in the range that does not contradict FIG. 1.

Step S300, which produces a composite film such that the first electrode powder film F1, the second electrode powder film F2, and the third electrode powder film F3 are sequentially stacked, includes steps to simultaneously unwind a first electrode powder film F1, a second electrode powder film F2, and a third electrode powder film F3 manufactured through each powder film forming process. The first to the third electrode powder films (F1 to F3) with different degrees of electrochemical resistance can be unwound to be stacked in the order from electrode powder with the highest resistance to electrode powder with lowest resistance, for example, to the third to first electrode powder.

Step S300, which produces a composite film (SF) such that the first electrode powder film F1, the second electrode powder film F2, and the third electrode powder film F3 are sequentially stacked, includes a hot-pressing step. By hot-pressing the first to the third electrode powder films in an aligned state, heat energy can be applied to produce the electrode powder films (F1 to F3) into one composite film (SF).

In an embodiment, the hot-pressing step may utilize a roll press or belt press. For example, the hot-pressing step can be performed using at least one roll 221, and the example is a non-limiting example. Various types of hot-pressed methods can be used if the electrode powder films can be uniformly aligned to produce a single composite film. Through the hot-pressing step, the composite film formed may be laminated in the order of first composite layer 120, second composite layer 130, and third composite layer 140.

In an embodiment, after the hot-pressing step, both non-uniform edges of the hot-pressed composite film (SF) can be uniformly cut by the uniform unit 222. For a detailed description of this, please refer to step S100, which produces the first electrode powder film.

Step S300 of manufacturing the composite film so that the first electrode powder film F1, the second electrode powder film F2, and the third electrode powder film F3 are sequentially stacked may include a step of winding the composite film (SF). For a detailed description of this, please refer to step S100, which produces the first electrode powder film.

Step S400, which laminates by pressing at least one composite film (SF) and substrate film (base film, BF), includes a step of unwinding the substrate film and at least one composite film (SF). The substrate film can be unwounded while disposed in contact with at least one of the composite films with high resistance, for example, the third composite layer 140 of FIG. 1.

To manufacture a single-coated electrode, the base film (BF) can be unwound with one composite film (SF), and to manufacture a double-coated electrode, the base film can be unwound with two composite films (SF, SF′). To manufacture the double-coated electrode, each third composite layer of the composite film can be disposed in contact with the base film.

At least one step S400, which laminates the composite film (SF) and the base film (BF) by pressing, heats the mixture film (SF) and the base film (BF) so that the mixture film (SF) and the base film (BF) are bonded. It may include steps in which at least one of the pressures is performed. The step in which at least one of the heat and pressure is performed can use at least one of the surface pressure and linear pressure. If the surface pressure is used, a belt press can be used, and if the linear pressure is used, a roll press can be used, which is a non-limiting example. In FIG. 2D, a method using roll press equipment 311 is shown, but it is not limited to this, and heat and pressure can be applied by various methods.

In an embodiment, step S400 of lamination by pressing at least one composite film (SF) and base film (BF) may further include a step of applying heat by the heating unit 312. The heating unit 312 can apply heat to at least one composite film (SF) and the base film (BF) to impart adherence to the binder contained in the composite film (SF). As a result, it is possible to improve the adherence of layers in composite film and the adherence between the composite film (SF) and the base film (BF).

In an embodiment, step S400 of pressing and laminating at least one composite film (SF) and a base film (BF) may be followed by a step of winding the bonded films onto a battery electrode roll of a certain length. By winding the bonded films into a roll, a battery electrode (BE) can be manufactured.

### Example and Comparative Example

### Measurement of Electrochemical Resistance

For electrochemical resistance, the ratio of 1 C charge capacity to 0.33 C charge capacity was used as a value to confirm the relative comparison of electrochemical resistance, based on a graphite negative electrode with a loading of 20 mg/cm².

### Measurement of Adherence Between Substrate/Composite Layers

Adherence between substrate/composite layers was measured by cutting electrodes to 20 mm wide and 120 mm length, attaching tape to the composite layer, and then performing a peel test using a tensile tester (AGX, Shimadzu).

The following Table 1 shows the measurement distribution of electrochemical resistance and adherence measurement between substrate/composite layers in Example and Comparative Example according to binder distribution.

TABLE 1

| | | Content of | Content of | Content of | | |
|---|---|---|---|---|---|---|
| | | first | second | third | 1 C charge | Adherence between |
| | | composite | composite | composite | capacity/0.33 C | substrate/composite |
| graphite negative electrode | | layer binder | layer binder | layer binder | charge | layer |
| (Total loading: 20 mg/cm²) | | [1 wt %] | [2 wt %] | [3 wt %] | capacity × 100% | [gf/mm] |
| Example | stacking order | 1 | 2 | 3 | 68% | 9.02 gf/mm |
| Comparative | (direction: top → | 3 | 2 | 1 | 53% | 1.25 gf/mm |
| Example | down) | | | | | |

Looking at Table 1, the charge capacity and adherence between substrate/composite layers of the Example in which the first, second, and third composite layer binder contents of 1, 2, and 3 wt %, respectively, were laminated in the top-down direction, and the Comparative Example laminated in the opposite direction, was measured. It was confirmed that the Example was superior to the Comparative Example. The following Table 2 shows data showing different electrochemical resistances depending on the particle size of the first composite layer to the third composite layer, and thus different adherence between the substrate and composite layer.

TABLE 2

| graphite negative | | | | 1 C charge |
|---|---|---|---|---|
| electrode | Particle size of | Particle size of | Particle size of | capacity/ |
| (Total loading: | first composite | second composite | third composite | 0.33 C charge |
| 20 mg/cm²) | layer [μm] | layer [μm] | layer [μm] | capacity × 100% |
| Example | 16 | 21 | 25 | 64% |
| Comparative | 25 | 21 | 16 | 55% |
| Example | | | | |

In Table 2, an Example in which the particle size of the first to third composite layer satisfies the range of the present disclosure and a Comparative Example that does not satisfy the range of the present disclosure was evaluated. It was confirmed that the electrochemical characteristics of the examples were excellent.

The present disclosure is not limited to the embodiments, but can be manufactured in a variety of different forms. Additionally, in the technical field to which the present disclosure belongs, a person of an ordinary skill in the art can manufacture the embodiments described in the present disclosure in a variety of different forms without changing the technical idea or essential features of the present disclosure. It should be understood that it can be implemented in other specific forms. Therefore, the embodiments described above should be understood in all respects as illustrative and not limiting.

What is claimed is:

1. A battery electrode, comprising:
a separator;
a first composite layer disposed on the separator and comprising a first active material, a first binder, and a first conductive material;
a second composite layer disposed on the first composite layer and comprising a second active material, a second binder, and a second conductive material;
a third composite layer disposed on the second composite layer and comprising a third active material, a third binder, and a third conductive material; and
a substrate disposed on the third composite layer,
wherein, a resistance of the first composite layer is less than a resistance of the second composite layer, and
the resistance of the second composite layer is less than a resistance of the third composite layer.

2. The battery electrode of claim 1, wherein:
the resistance of the first composite layer is in a range of 40 to 60% and,
the resistance of the second composite layer is in a range of 60 to 70% and,
the resistance of the third composite layer is in a range of 65 to 85%.

3. The battery electrode of claim 1, wherein:
the first active material, the second active material, and the third active material comprise at least one of a carbon-based material or a metal-based material.

4. The battery electrode of claim 1, wherein:
a content of the first binder is less than a content of the second binder,
the content of the second binder is less than a content of the third binder,
the content of the first binder is in a range of 0.1 to 1.5 wt % based on the overall composition of the first composite layer,
the content of the second binder is in a range of 0.5 to 2.5 wt % based on the overall composition of the second composite layer, and
the content of the third binder is in a range of 1.0 to 3.5 wt % based on the overall composition of the third composite layer.

5. The battery electrode of claim 1, wherein:
the first binder, the second binder, and the third binder are independently selected from the group consisting of polyvinylidene fluoride-hexafluoropropylene, polyvinylidene fluoride, polyacrylonitrile, polymethyl methacrylate, styrene-butadiene rubber, carboxyl methyl cellulose, and combination thereof.

6. The battery electrode of claim 1, wherein:
a particle size of the first composite layer is in a range of 12 to 20 micrometers (μm),
a particle size of the second composite layer is in a range of 20 to 25 μm, and
a particle size of the third composite layer is in a range of 25 to 30 μm.

7. A method of manufacturing battery electrode, comprising:
preparing a first electrode powder film;
preparing a second electrode powder film and a third electrode powder film respectively by the same method as preparing the first electrode powder film;
preparing a composite film such that the first electrode powder film, the second electrode powder film, and the third electrode powder film are sequentially stacked on top of one another; and
laminating by pressing at least one of the composite films and a substrate together,
wherein, a resistance of the first electrode powder film is less than a resistance of the second electrode powder film, and
wherein the resistance of the second electrode powder film is less than a resistance of the third electrode powder film.

8. The method of claim 7, wherein preparing the first, second and third electrode powder films comprises:
mixing a first electrode powder, a second electrode powder, and a third electrode powder, respectively,
wherein, the first electrode powder comprises a first active material, a first binder, and a first conductive material,
wherein the second electrode powder comprises a second active material, a second binder, and a second conductive material,
wherein the third electrode powder comprises a third active material, a third binder, and a third conductive material,
wherein a content of the first binder is less than a content of the second binder, and
wherein the content of the second binder is less than a content of the third binder.

9. The method of claim 8, wherein:
a content of the first conductive material is greater than a content of the second conductive material, and
a content of the second conductive material is greater than a content of the third conductive material.

10. The method of claim 7, wherein preparing the first, second and third electrode powder films comprises:
pressurizing first electrode powder, second electrode powder, and third electrode powder, respectively, into a film;
edge slitting the first electrode powder film, the second electrode powder film, and the third electrode powder film; and
winding each of the edge-slitted first electrode powder film, second electrode powder film, and third electrode powder film.

11. The method of claim 10, wherein respectively pressurizing first electrode powder, second electrode powder, and third electrode powder into a film comprises: controlling a thickness of each of the first electrode powder, the second electrode powder, and the third electrode powder.

12. The method of claim 11, further comprising:
uniformly cutting, by a cutting unit, sides of each of the first electrode powder film, the second electrode powder film, and the third electrode powder film, along a length direction thereof.

13. The method of claim 7, wherein:
the laminating comprises:
unwinding the composite film and the substrate; and
bonding a first mixture film, the substrate, and a second mixture film by applying at least one of heat or pressure to the unwound composite film and the substrate in the same order as unwinding the composite film and the substrate.

14. The method of claim 13, further comprising:
winding the bonded first mixture film, substrate and second mixture film onto a battery electrode roll having a predetermined length.
